(19) United States
(12) Patent Application Publication
(10) Pub. No.: US 2006/0152541 A1
(43) Pub. Date: Jul. 13, 2006

(54) Droplet discharging apparatus

(76) Inventors: Jun Isozaki, Kanagawa (JP); Kishiharu Itazu, Kanagawa (JP); Naoki Morita, Kanagawa (JP); Satoshi Yashima, Kanagawa (JP)

Correspondence Address: FILDES & OUTLAND, P.C., Suite 2, 20916 Mack Avenue, Grosse Pointe Woods, MI, 48236, US

(21) Appl. No.: 11/299,531

(22) Filed: Dec. 12, 2005

(30) Foreign Application Priority Data
Dec. 24, 2004 (JP) 2004-374599
Sep. 26, 2005 (JP) 2005-278809

(51) Int. Cl. B41J 29/38

(52) U.S. Cl. 347/17

(57) ABSTRACT

The droplet discharging apparatus of the present invention comprises: droplet discharging heads that discharge a discharge fluid in droplet form; multiple head drive elements that drive the droplet discharging heads; and a heat-dissipating block that is thermally connected to the respective head drive elements and which has a discharge fluid flowing conduit therein that cools the head drive elements by making the discharge fluid flow through.

### CROSS-REFERENCE TO RELATED APPLICATION

This application claims priority under 35 U.S.C. 119 from Japanese Patent Application No. 2005-278809 the disclosure of which is incorporated by reference herein.

### BACKGROUND OF THE INVENTION

1. Field of the Invention

The present invention relates to a droplet discharging apparatus. Specifically, the present invention relates to a droplet discharging apparatus that discharges ink as a discharge fluid, wherein the device has a large wide-range discharging head that exhibits little temperature variation inside the discharging head, and drive control of the head can be easily performed.

2. Description of the Related Art

Among current inkjet recording apparatus, inkjet heads on whose entire surfaces nozzles that eject ink are formed are used. In recent years, inkjet heads have been increasing in both size and width. Paper-width inkjet heads that print across the entire width of the recording paper have also come to be widely used.

In some types of a paper-width head, temperature variations can occur when printing a specific printing pattern. For this reason, the paper-width head is separated into a plurality of blocks and a complicated drive control, e.g., controlling each of the blocks in different driving conditions in accordance with the temperature of the blocks.

Unlike thermal inkjet-type heads, Piezoelectric-type inkjet heads that eject ink by deformation of piezo elements do not use thermal energy to eject the ink. Nonetheless, drive elements such as a switching IC, which drives the piezo elements, and a switching IC control board that controls the IC, as well as a head drive IC are all provided within the vicinity of the inkjet head. Additionally, heat generation from the drive elements have also increased with the increases in inkjet head size. In devices equipped with paper-width heads having multiple colors, the amount of heat generated by these drive elements is quite marked.

Piezo elements also cannot be operated when the drive elements get too hot, thus it is necessary to cool the drive elements.

Method for cooling the driving elements includes following methods: temporarily stopping operation of the inkjet head and leave it cool; cooling the inkjet head by a heat-radiating component such as a heat sink; and water-cooling the inkjet head by using a heat sink and a heat pipe.

Nonetheless, it has a shortcoming to cool the inkjet head by using a heat sink in that the inkjet recording apparatus would become too large in whole size thereof and too costly. While, there is a defect in the method of temporarily stopping operation of the inkjet head to cool it naturally that printing throughput is reduced since it takes long hours for cooling the driving unit.

Accordingly, it has been devised to cool the inkjet head with the ink itself. Examples of such inkjet recording apparatus are as follows:

An inkjet recording apparatus comprising a circulation-type recovery device that makes ink circulate in an inkjet head thereof, where the ink is circulated though the circulation-type recovery device so as to cool the inkjet head when the temperature of the inkjet head exceeds a predetermined temperature (see the Official Gazettes of the Japanese Patent Application (JP-A) No. 7-004940 (examined) and JP-A No. 1-156073 (unexamined)); and

An inkjet recording apparatus comprising a circulation-type recovery device that makes ink circulate in the inkjet head, wherein the amount of the ink circulating in the circulation-type recovery device in accordance with the temperature of the inkjet head (see the Official Gazettes of the JP-A No. 1-154761 and No. 11-010908).

Furthermore, a pigment ink in which a pigment is incorporated has become to be widely adopted so as to improve coloring and robustness of printed images.

However, pigment ink generally has a higher viscosity than a dye ink, accordingly, a pigment ink has a poorer discharging efficiency than a dye ink when a driving wave of the same voltage is applied to the inkjet heads. Here, the driving element needs to apply driving wave of a higher voltage to the discharging heads so as to discharge a pigment ink at the same discharging efficiency as a dye ink. Additionally, compared with a dye ink, discharging a pigment ink is highly dependent on a wave form of a driving wave and is strongly affected by an ambient temperature and thus, the load of the driving circuit is higher when discharging a pigment ink.

For resolving the above problem, it has been proposed to control a driving wave voltage in accordance with the type of ink discharged and an ambient temperature (see the Official Gazette of JP-A No. 11-115197 (unexamined)).

It has been also proposed to provide a heater and a temperature sensor in an inkjet head and warm the ink discharged from the inkjet head (see the Official Gazette of JP-A No. 2000-153608 (unexamined)).

In a piezoelectric-type inkjet head, a large number of pressure chambers ejecting ink piezoelectricaly by piezo elements are provided. In order to stably eject ink from these pressure chambers, it is necessary to maintain the pressure inside the pressure chambers at a constant level.

However, as disclosed in the Official Gazettes of JP-ANos. 1-154761, 1-156073, and 11-010908, when ink is circulated to the pressure chambers in order to cool the inkjet head, the pressure inside the pressure chambers fluctuates. This can cause problems where ink cannot be ejected or, even when ink can be ejected, the diameters of the ink droplets become overly large.

Accordingly, there is a problem of throughput decrease since driving of the inkjet head is necessarily ceased when circulating ink to the pressure chambers.

Further, ink is circulated in the pressure chambers in the inkjet head from one end to the other sequentially. Accordingly, if for some reason the inkjet head becomes hotter in a certain region, it is difficult to make the temperature of the inkjet head uniform in a short period of time.

Furthermore, a complicated controlling circuit is needed to control the drive element when controlling driving wave voltage in accordance with the type of ink and an ambient temperature as recited in JP-A No. 11-115197 so as to discharge a pigment ink with the same efficiency as a dye ink.

Further, providing extra components such as a heater for heating the ink and a temperature sensor, as disclosed in JP-A No. 2000-153608, contributes to increasing the cost of an apparatus.

### SUMMARY OF THE INVENTION

The present invention has been made in view of the above circumstances and provides a droplet discharging apparatus comprising: a plurality of droplet discharging heads that discharge a discharge fluid in droplet form; a plurality of head drive elements that drive the droplet discharging heads; and a heat-dissipating block that is thermally connected to the respective head drive elements and which has a discharge fluid flowing conduit therein that cools the head drive elements by making the discharge fluid flow therethrough.

### BRIEF DESCRIPTION OF THE DRAWINGS

Preferred embodiments of the present invention will be described in detail based on the following figures, wherein:

FIG. 1 is an explanatory drawing showing the overall structure of an inkjet printer of a first embodiment;

FIG. 2 is an explanatory drawing showing a different example of the inkjet printer of the first embodiment;

FIGS. 3A and 3B are perspective drawings showing embodiments of the inkjet printers shown in FIG. 1 or 2 provided with ink conduits inside the heat-dissipating blocks;

FIG. 4 is a schematic explanatory drawing showing the relation between the types of images and the head temperature in a case where ink is not circulated through the conduits;

FIG. 5 is a schematic explanatory drawing showing the relation between the head temperature and the input waveforms;

FIG. 6A is a schematic explanatory drawing showing the behavior of the pigment particles in the sub-tank when the ink is circulated, in a case where pigment ink is used; and FIG. 6B is a schematic explanatory drawing showing the behavior of the pigment particles in the sub-tank when the ink is not circulated;

FIG. 7 is an explanatory drawing showing the overall structure of an inkjet printer of a second embodiment;

FIG. 8 is an explanatory drawing showing a different example of the inkjet printer of the second embodiment;

FIG. 9 is a schematic perspective view showing the overall structure of an inkjet printer of a third embodiment;

FIG. 10 is an enlarged perspective drawing showing in detail the structure of the head bar unit in the inkjet printer of the third embodiment;

FIG. 11 is an enlarged perspective drawing showing an example where a heater is provided at an ink-supplying pipe that supplies ink to heat-dissipating blocks provided at the head bar units in the inkjet printer of the third embodiment;

FIG. 12 is an enlarged perspective drawing showing an example where a heater and a cooler are provided at the ink-supplying pipe in the inkjet printer of the third embodiment;

FIG. 13 is an explanatory drawing showing the overall structure of an inkjet printer of a fourth embodiment;

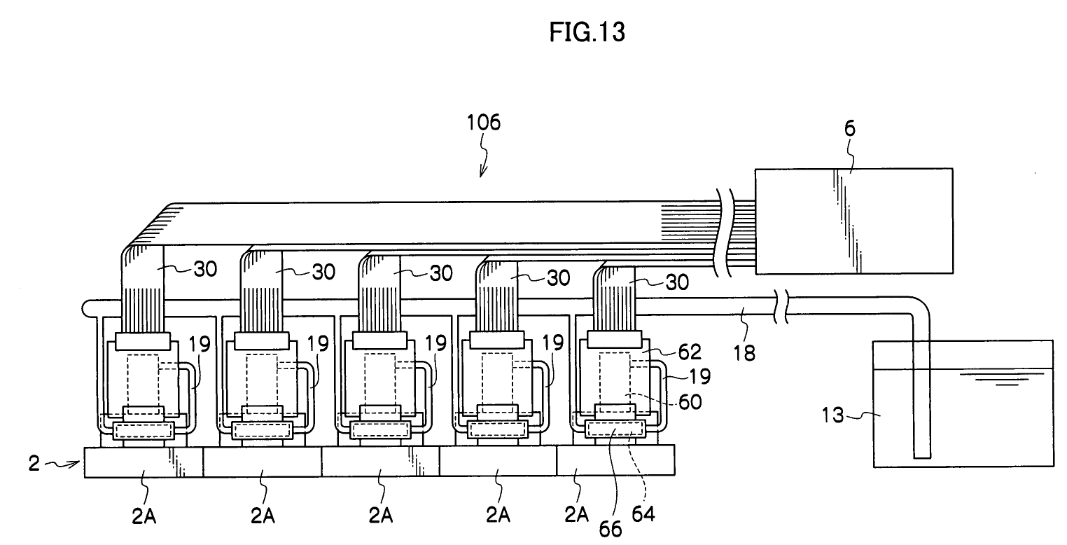

FIG. 14 is an enlarged drawing showing the head unit and the details of the structure surrounding it in the inkjet printer of the fourth embodiment;

FIG. 15 is an explanatory drawing showing the transfer of data in the head drive circuit, the switch IC control board, and the temperature sensor in the inkjet printer of the fourth embodiment;

FIGS. 16A to 16D are waveform drawings showing the shape of driving wave output from the switch IC control board to the switch IC;

FIGS. 17A to 17D are waveform drawings showing one example of analog waveforms that drive piezo elements; and

FIG. 18 is an explanatory drawing showing the operation of the inkjet printer of the fourth embodiment from the printing standard stage to during printing and to when printing is completed.

### DETAILED DESCRIPTION OF THE INVENTION

### 1. First Embodiment

An inkjet printer that is an example of the droplet discharging apparatus of the present invention is described in the following.

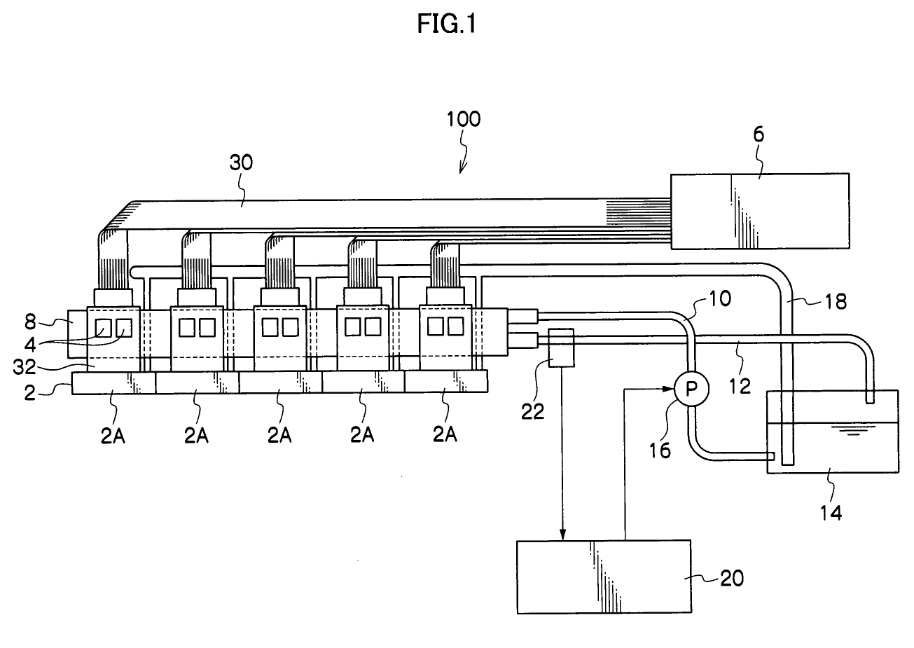

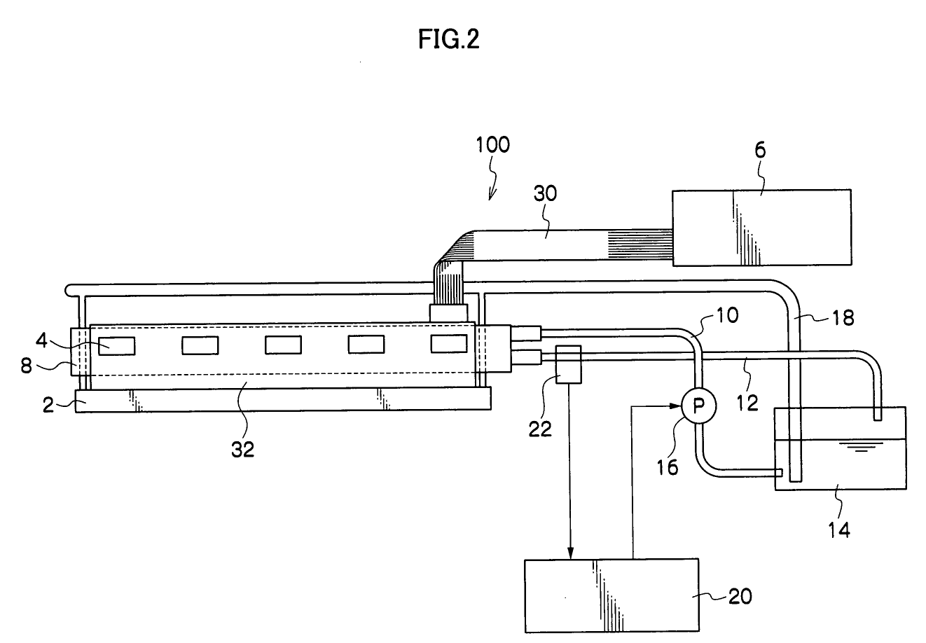

As seen in FIG. 1, the inkjet printer 100 of a first embodiment has an inkjet head 2 that is a piezoelectric inkjet head. The inkjet head 2 is one example of the droplet discharging apparatus of the present invention and can comprise, as shown in FIG. 1, a plurality of, e.g., five head units 2A lined in the longitudinal direction, or can comprise, as shown in FIG. 2, one inkjet head formed into a bar shape.

Nozzle holes (not shown) from which ink is ejected are provided in a matrix pattern on the undersurface of the inkjet head 2, that is, on the surface facing the recording paper. Also, a pressure chamber (not shown) corresponding to each nozzle hole is also provided. Further, a portion of the wall surface of each pressure chamber is formed of a diaphragm driven by a piezo element. Accordingly, when pulse is applied to a piezo element, ink is ejected from the nozzle holes formed at the pressure chamber corresponding to the piezo element.

A head drive circuit 6 that generates waves that drive the inkjet head 2 based on input image signals is further provided at the inkjet printer 100 while head drive ICs 4 that are one example of possible head drive elements are respectively provided at each of the head units 2A. The head drive ICs 4 correspond to the head drive elements in the present invention. Each head drive IC 4 has a function in that it selects, from among the input driving waves input from the head drive circuit 6, which driving waves are input into which piezo element of the head units 2A. The head drive IC 4 also inputs the driving wave into the selected piezo element and then makes it eject ink. It should be noted that an embodiment of the inkjet printer 100 shown in FIG. 2, which has an inkjet head 2 formed as one bar-shaped unit, also has five head drive ICs 4. In the embodiment shown in FIG. 2, each head drive IC 4 has a function of selecting driving waves input from the head drive circuit 6 and inputting them into an appropriate piezo element of the inkjet head 2.

The head drive circuit 6 and each of the five head drive ICs 4 are connected by a flexible cable 30 formed in a flexible tape form. In the head units 2A, the head drive IC 4 and each of the piezo elements are connected similarly by a flexible cable 32 having a flexible tape form. In the embodiment shown in FIG. 2, the five head drive ICs 4 are connected to the piezo elements provided in the inkjet head 2 by the flexible cable 32 while at the same time, the flexible cable 30 that conveys signals from the head drive circuit 6 to the head drive ICs 4 is also connected to the head drive ICs 4 by the flexible cable 32.

The five head drive ICs 4 are thermally connected to a heat-dissipating block 8.

The heat-dissipating block 8 and a sub-tank 14 that temporarily accumulates ink are connected by ink circulation pipes 10 and 12. The ink circulation pipes 10 and 12 correspond to the discharge fluid flowing conduits of the present invention. Among the ink circulation pipes 10 and 12, a pump 16 is provided at the ink circulation pipe 10, which is on the side that supplies ink to the heat-dissipating block 8. The ink circulation pipe 12 is the pipe that returns the ink circulated through the heat-dissipating block 8 to the sub-tank 14. Further, the ink circulation pipe 10 opens close at the bottom portion of the sub-tank 14, while the ink circulation pipe 12 opens at the ceiling of the sub-tank 14.

Additionally, an ink-supplying pipe 18 that supplies ink to the inkjet head 2 is provided at the sub-tank 14 independently of the ink circulation pipes 10 and 12. The ink-supplying pipe 18 also opens at the bottom portion of the sub-tank 14. In the embodiment shown in FIG. 1, ink is supplied to each of the head units 2A from the sub-tank 14 through the ink-supplying pipe 18. On the other hand, in the embodiment shown in FIG. 2, the ink-supplying pipe 18 is connected to both ends of the inkjet head 2.

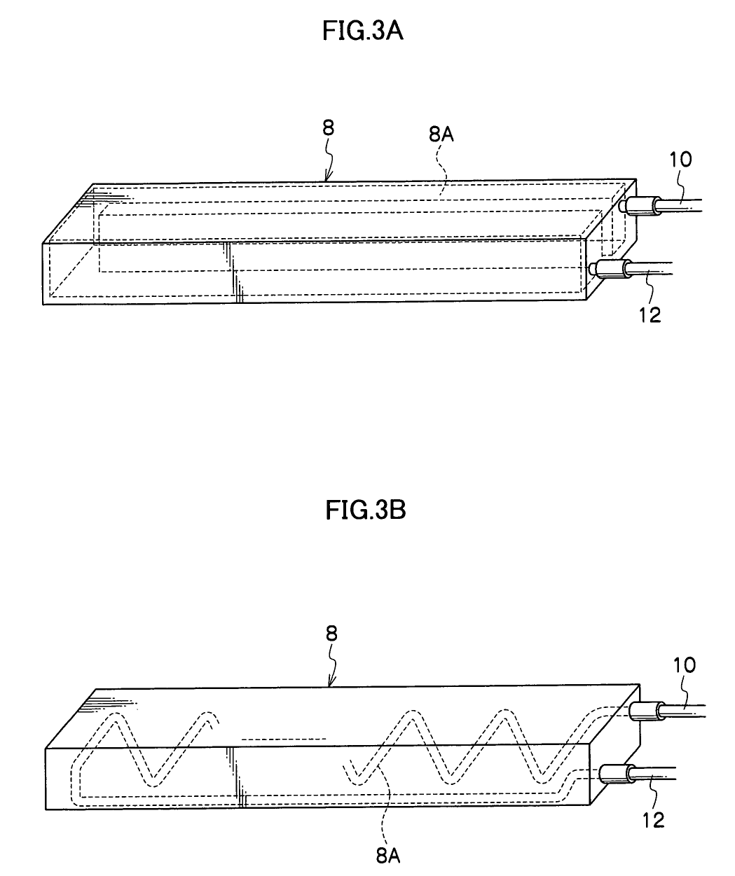

As shown in FIG. 3A, a discharge fluid flowing conduit 8A set in the interior of the heat-dissipating block 8 can be a simple U-shaped or, as shown in FIG. 3B, zigzag conduit. The head drive ICs 4 can be cooled more efficiently by the discharge fluid flowing conduit 8A having the zigzag shape.

In both of the embodiments shown in FIGS. 1 and 2, a temperature sensor 22 is provided at the ink circulation pipe 12. The temperature sensor 22 and the pump 16 are connected to an ink circulation system control circuit 20 that controls the ink circulation system that circulates ink to the heat-dissipating block 8. The temperature sensor 22 corresponds to the temperature detecting device of the present invention and the aforementioned pump 16 and ink circulation system control circuit 20 correspond to the discharge fluid flow amount control device of the present invention.

A conventional dye ink as well as a pigment ink can be used in the inkjet printer 100. Additonally, an ink in which a dye and a pigment are incorporated as a colorant can be used. Further, the ink can be an aqueous type ink or an organic solvent-type ink.

The function of the inkjet printer 100 is described in the following.

When image signals are input into the head drive circuit 6, driving waves corresponding to these image signals are generated in the head drive circuit 6.

The driving waves generated at the head drive circuit 6 are input into each head drive IC 4, after which each of the head drive ICs 4 selects piezo elements of the head units 2A into which the driving waves are to be input, and then inputs the driving waves into the selected piezo elements. Thus, ink is ejected from predetermined nozzles of the head units 2A and printing images are formed.

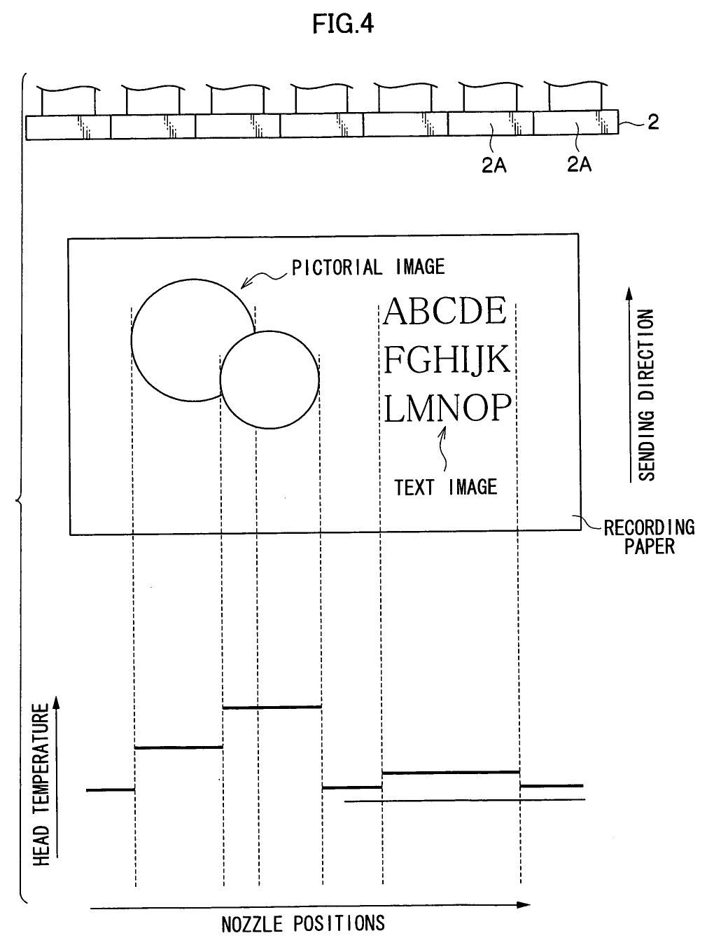

Heat is generated at each head drive IC 4 in accordance with printing area and the size of the ink droplets discharged. Specifically, when text images mainly consisting of characters and symbols are printed, the temperature of the head drive ICs 4 does not increase not so much since the printing area is not so large. Accordingly, as shown in FIG. 4, the portions of the inkjet head 2 wherein text images are printed exhibit little temperature increase. On the other hand, pictorial images, which mainly consist of photographs and illustrations, are printed in a high printing density, and thus, each head drive IC 4 generates larger amount of heat. Especially, a deep colored portion of the pictorial images has a higher printing density and thus, the head drive ICs 4 generate a huge amount of heat.

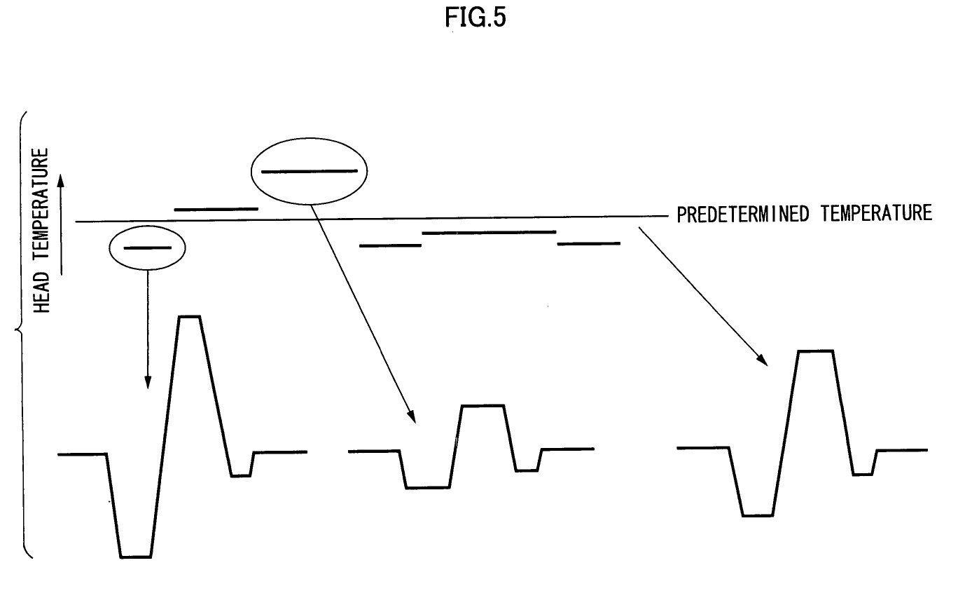

When the temperature of the inkjet head 2 rises, the viscosity of the ink circulating in the interior declines. For this reason, when the same driving waves are applied to all of the nozzles of the inkjet head 2 when the inkjet head 2 has both hotter and colder portions, ink discharging irregularities occur. This is due to the fact that a large amount of ink is discharged from the nozzles of the hotter portions while only a small amount ink is discharged from the nozzles of the colder portions. As shown in FIG. 5, in order to prevent such discharging irregularities, to the colder portions of the inkjet head 2, driving waves having a larger absolute value of a crest height and trough depth are necessarily input. On the contrary, to the hotter portions of the inkjet head 2, driving waves having a smaller absolute value of a crest height and trough depth should be input.

However, with the inkjet printer 100, the ink from inside the sub-tank 14 passes through the ink circulation pipes 10 and 12 and circulates through the heat-dissipating block 8, so the heat generated at each head drive IC 4 is eliminated by the ink circulating within the heat-dissipating block 8.

The temperature of the discharge fluid that passes through the ink circulation pipe 12 from the heat-dissipating block 8 and returns to the sub-tank 14 is detected by the temperature sensor 22. The detection results of the discharge fluid temperature in the temperature sensor 22 are input to the ink circulation system control circuit 20.

When the discharge fluid temperature input to the ink circulation system control circuit 20 is higher than a predetermined temperature T, the ink circulation system control circuit 20 increases the revolutions of the pump 16 and increases the amount of ink flow distributed to the heat-dissipating block 8. Accordingly, the amount of heat eliminated by the heat-dissipating block 8 increases and the temperatures of the head drive ICs 4 goes down.

Conversely, when the input temperature of the discharge fluid is lower than the predetermined temperature T, the ink circulation system control circuit 20 decreases the revolutions of the pump 16 and thus the amount of ink flow distributed to the heat-dissipating block 8 is decreased. Thus, the amount of heat eliminated by the heat-dissipating block 8 decreases and the temperatures of the head drive ICs 4 raises.

In the inkjet printer 100, since all of the five head drive ICs 4 are thermally connected with the same heat-dissipating block 8, even if one of the head drive ICs 4 suddenly heats up, the generated heat is conveyed to the other head drive ICs 4 via the heat-dissipating block 8, and then the heat is eliminated by the ink circulating within the heat-dissipating block 8, and thus, the head drive IC 4 would not be overheated. Accordingly, the temperature of each head drive IC 4 is maintained at a constant regardless of the type of image printed by the inkjet head 2. It can be applied to the case when mixed images of text images and pictorial images are printed by the inkjet head 2.

Further, the fluid temperature of the ink circulating within the heat-dissipating block 8 is maintained at a constant due to the temperature sensor 22, the ink circulation system control circuit 20 and the pump 16, so the temperature of the ink passing through the ink-supplying pipe 18 and supplied to each head unit 2A is also maintained at a constant level, regardless of the type of image printed by the inkjet head 2.

Accordingly, it is not necessary to change the waveforms of the driving waves input to the head drive ICs 4 from the head drive circuit 6 in accordance with the type of images to be printed by the inkjet head 2, changes in temperature of the inkjet head 2 itself, or changes in ink temperature. For this reason, the structure and control logic of the head drive circuit 6 can be greatly simplified.

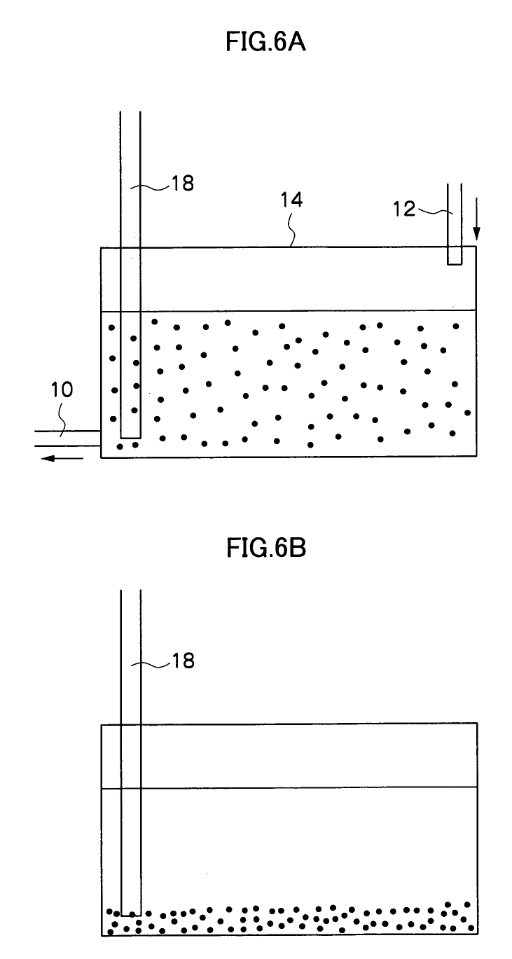

Here, in case where a pigment ink is used, as shown in FIG. 6B, without stirring or agitating in the sub-tank 14, the pigment in the ink is precipitated at the bottom thereof. Consequently, ink having a high concentration of pigment is supplied to the inkjet head 2 just after when printing is started. When printing proceeds, the amount of the ink in the sub-tank 14 is reduced and the pigment concentration in the ink will decrease. Thus, the density of printed images is lowered.

Nonetheless, in the inkjet printer 100, as shown in FIGS. 1 and 2, the ink circulation pipe 10, through which ink is to be extracted from the sub-tank 14, communicates with the sub-tank 14 at a portion close to the bottom thereof. Further, the ink circulation pipe 12, through which ink is to be returned to the sub-tank 14, communicates with the sub-tank 14 at a portion close to the ceiling thereof. Accordingly, as long as the pump 16 operates, the ink inside the sub-tank 14 is always extracted through the ink circulation pipe 10 from the bottom portion thereof. After being circulated inside the heat-dissipating block 8, the ink is returned through the ink circulation pipe 12 to the sub-tank 14 at a portion close to the ceiling thereof.

Accordingly, the ink inside the sub-tank 14 is constantly agitated and thus, ink having a regular composition is supplied to the inkjet head 2 and periodical change of the pigment density in the ink are prevented.

Additionally, the discharge fluid flowing conduits comprising the ink circulation pipes 10 and 12 and the heat-dissipating block 8 are separate conduits from the ink-supplying conduit formed by the ink-supplying pipe 18. The amount of ink flow circulating in the ink-supplying conduit is unchanged by the ink flow circulating through the discharge fluid flowing conduits, so it is not necessary to halt printing even while passing ink through the heat-dissipating block 8. Accordingly, there are no occurrences of reduction of throughput.

### 2. Second Embodiment

Another example of an inkjet printer included in the droplet discharging apparatus of the present invention will be described in the following.

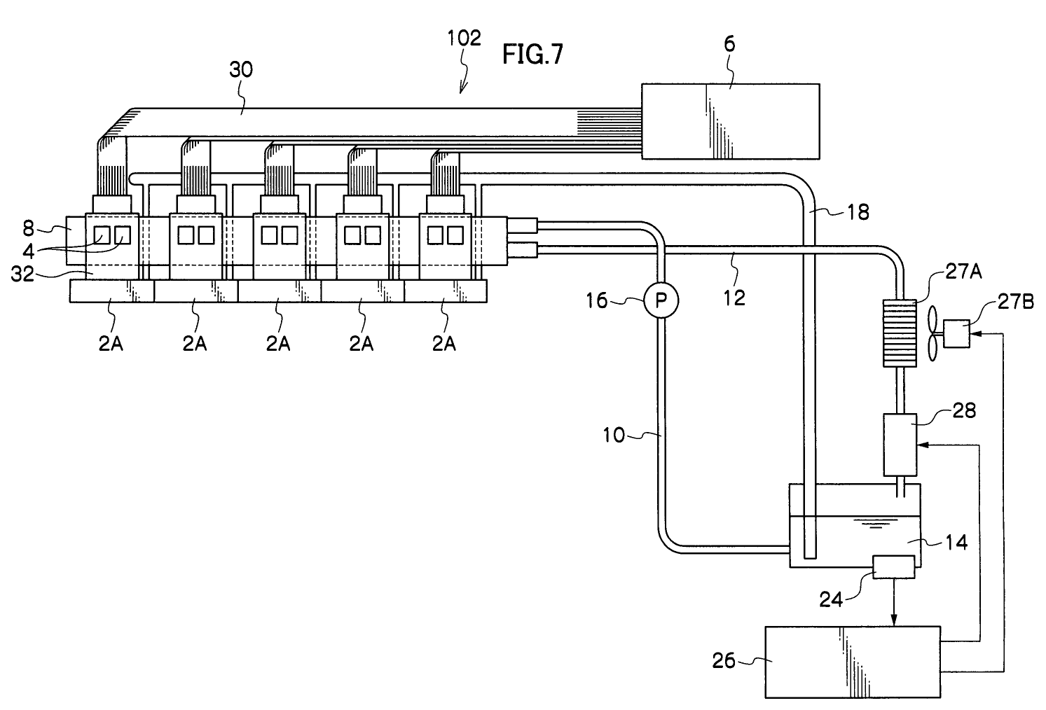

As shown in FIG. 7, in an inkjet printer 102 of a second embodiment, a cooler 27 and a heater 28 are provided on the ink circulation pipe 12 through which ink is returned from the heat-dissipating block 8 to the sub-tank 14. It should be noted that codes in FIG. 2 that are the same as the codes in FIG. 1 denote the same elements shown in FIG. 1. The cooler 27 and the heater 28 correspond to the discharge fluid temperature control device in the present invention.

The cooler 27 comprises a cooler fin 27A that cools the ink flowing through the ink circulation pipe 12 and a cooler fan 27B that blows cool air on the cooler fin 27A.

Further, the temperature sensor 24 that corresponds to the discharge fluid temperature detecting device is, unlike the inkjet printer 100 of the first embodiment, provided inside the sub-tank 14.

The inkjet printer 102 is further provided with an ink circulation system control circuit 26 that controls the cooler fan 27B and heater 28 based on the ink temperature detected by the temperature sensor 24.

With the exception of the above-described points, the inkjet printer 102 has the same constitution as the inkjet printer 100 of the first embodiment.

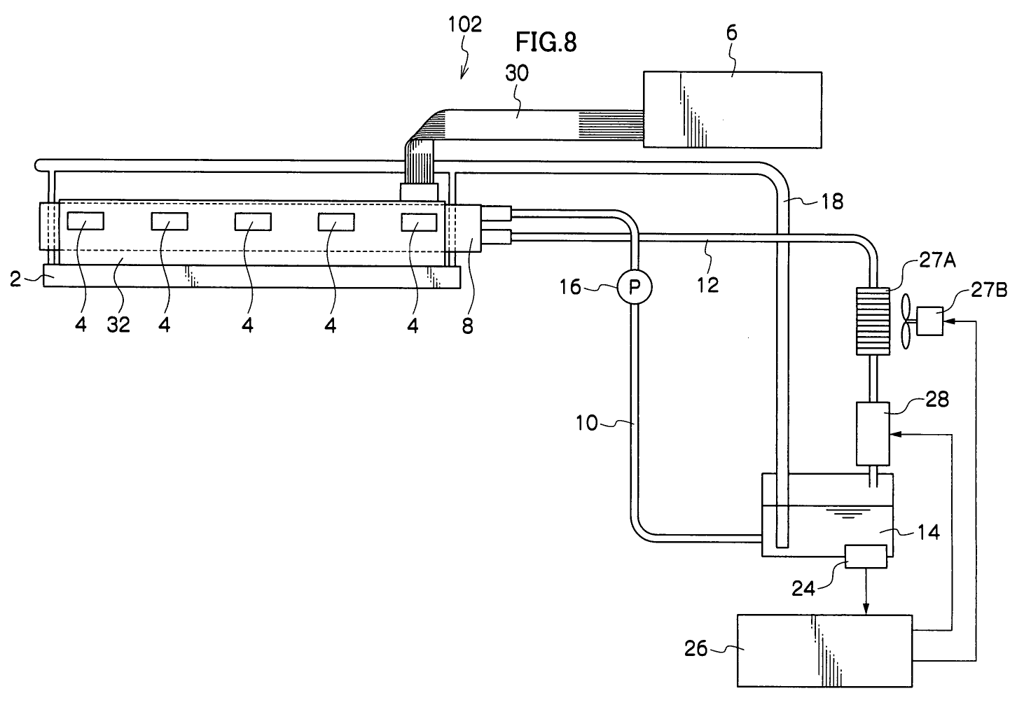

It should be noted that, as shown in FIG. 7, the inkjet head 2 can be divided into multiple, e.g., five, head units 2A or, as shown in FIG. 8, formed into a single bar-shaped head.

In an embodiment of the inkjet printer 102 where the inkjet head 2 is divided into five head units 2A, a head drive IC 4 is provided for each head unit 2A. Each head drive IC 4 and head unit 2A is connected by a flexible cable 32 while the head drive circuit 6 and each head drive IC 4 can be connected by a flexible cable 30.

On the other hand, in an embodiment where the inkjet head 2 is formed in a single bar shape, the five head drive ICs 4 and the inkjet head 2 can be connected by the flexible cable 32. The head drive circuit 6 can be connected to the flexible cable 32 by the flexible cable 30, whereby the head drive circuit 6 and each of the head drive ICs 4 are electrically connected.

The function of the inkjet printer 102 will be described in the following.

The head units 2A, the head drive ICs 4, and the head drive circuit 6 function in the same way as those in the inkjet printer 100 of the first embodiment.

The discharge fluid temperature in the sub-tank 14 detected by the temperature sensor 24 is input into the ink circulation system control circuit 26.

The input discharge fluid temperature is compared in the ink circulation system control circuit 26 with a lower-limit predetermined temperature T1 and with an upper-limit predetermined temperature T2.

When the discharge fluid temperature inside the sub-tank 14 is lower than the lower-limit predetermined temperature T1, first, the pump 16 is decelerated and the amount of ink being circulated is reduced to the lowest circulation amount. If even after that, the discharge fluid temperature is lower than the lower-limit predetermined temperature T1, the heater 28 is driven and the ink is heated.

On the other hand, when the discharge fluid temperature inside the sub-tank 14 is higher than the upper-limit predetermined temperature T2, first, the pump 16 is accelerated and the amount of ink being circulated is increased to the highest circulation amount. If even after that, the discharge fluid temperature is higher than the upper-limit predetermined temperature T2, the cooler 27 is driven and the ink is cooled.

When the discharge fluid temperature is between the lower-limit predetermined temperature T1 and the upper-limit predetermined temperature T2, the amount of flow of the pump 16 is adjusted so as to control the discharge fluid temperature at a predetermined temperature T that is between the lower-limit predetermined temperature T1 and the upper-limit predetermined temperature T2.

In the inkjet printer 102, not only the amount of flow in the pump 16 is controlled, but the discharge fluid temperature is controlled by cooling the ink by the cooler 27 or by heating it by the heater 28.

Further, not the temperature of the ink inside the discharge fluid flowing conduits but the discharge fluid temperature of the ink stored in the sub-tank 14 is detected.

Accordingly, the inkjet printer 102 of the present embodiment is preferable not only in the same point as the inkjet printer 100 of the first embodiment, but in that the temperature of the ink discharged from each head unit 2A can be maintained at a constant level, regardless of ambient temperature and the printing density or the like.

Therefore, the head drive circuit can always generate driving wave having the same waveform, and in comparison with the first embodiment, the structure and the control logic of the head drive circuit 6 can be further simplified.

### 3. Third Embodiment

An inkjet printer 104 that is yet another example of an inkjet printer that is included in the droplet discharging apparatus of the present invention will be described in the following.

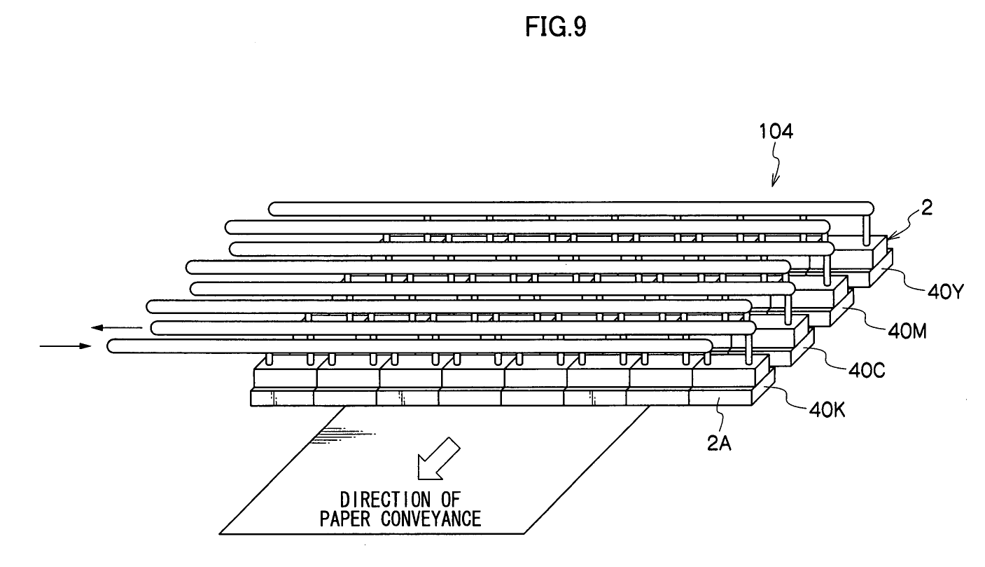

As shown in FIG. 9, the inkjet printer 104 of the third embodiment is provided with an inkjet head 40 that is a piezoelectric-type inkjet head that comprises four head units. These four head units are a head bar unit 40Y, a head bar unit 40M, a head bar unit 40C, and a head bar unit 40K, which are arranged along the direction in which the paper is conveyed from the upstream side to the downstream side. Here, the head bar unit 40Y is a head bar unit that ejects yellow (Y) ink and forms yellow images; the head bar unit 40M is a head bar unit that ejects magenta (M) ink and forms magenta images; the head bar unit 40C is a head bar unit that ejects cyan (C) ink and forms cyan images; and the head bar unit 40K is a head bar unit that ejects black (K) ink and forms black images.

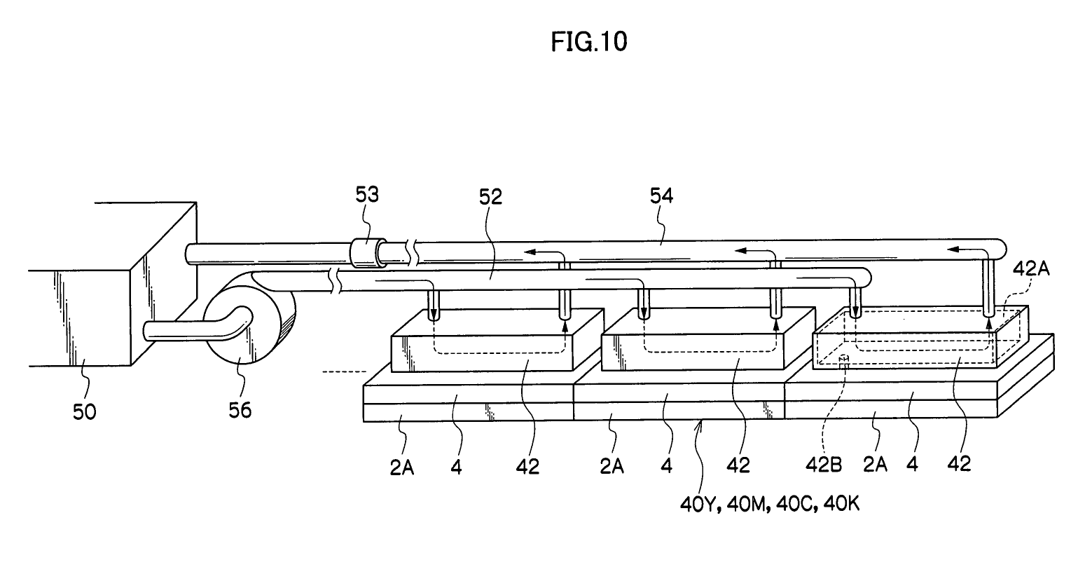

As shown in FIG. 10, the head bar units 40Y-40K comprises eight head units 2A arranged in a row in a direction perpendicular to the paper conveying direction, head drive ICs 4, which are layered or stacked on the upper surfaces of each of the head units 2A, and a heat-dissipating block 42 that is stacked on each head drive IC 4 and ink pools 42A are provided therein. The head drive ICs 4 select specific driving waves from the driving waves input from a head-driving circuit (not shown), choose specific piezo elements from the piezo elements of the head units 2A, and then, input the selected driving waves into the selected piezo elements so as to eject ink,

Ink-supplying conduits 42B that supply ink from the interior to the head units 2A are provided in the ink pools 42A such that they pass through the head drive ICs 4.

Each heat-dissipating block 42 is connected to a sub-tank 50 with an ink-supplying pipe 52 and an ink-returning pipe 54. Accordingly, the discharge fluid flowing conduits are formed of the ink-supplying pipe 52, the ink-returning pipe 54, and the ink pool 42A in each heat-dissipating block 42.

A temperature sensor 53 that detects the temperature of the ink that has returned from each heat-dissipating block 42 is provided at the ink-returning pipe 54. The temperature sensor 53 corresponds to the discharge fluid temperature detecting device of the present invention.

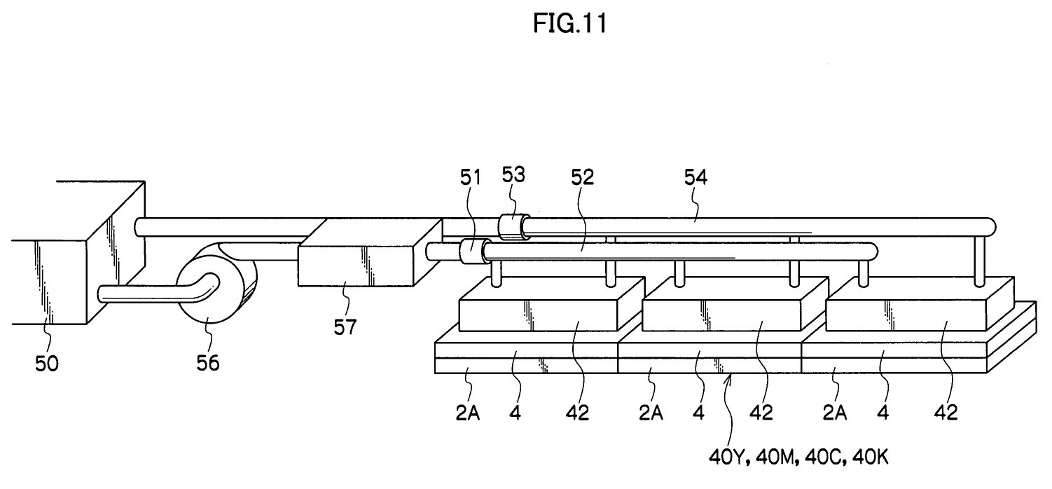

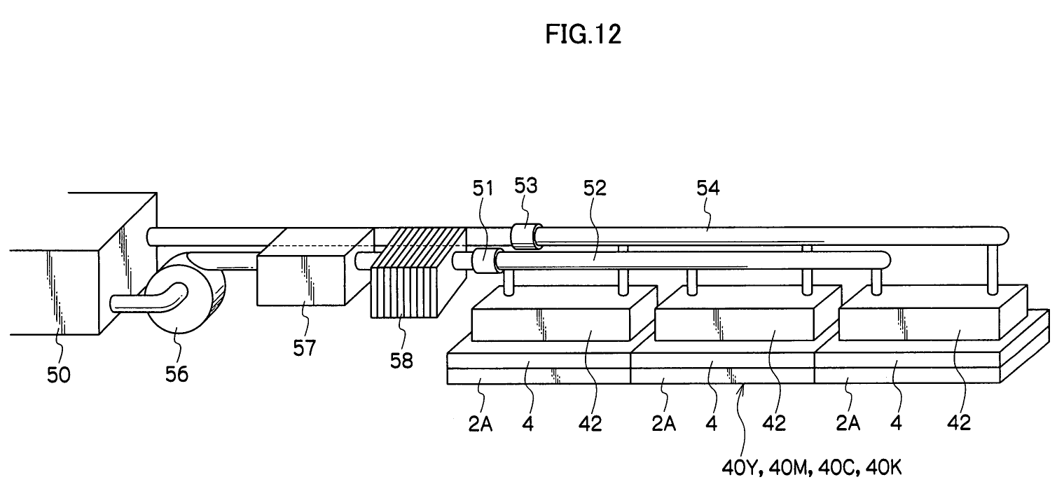

As shown in FIG. 11, a heater 57 that heats ink can be provided on the ink-supplying pipe 52 between a pump 56 and the head bar units 40Y-40K. Further, as shown in FIG. 12, in addition to the heater 57, a cooler 58 that cools ink can be provided between the heater 57 and the head bar units 40Y-40K. When providing the heater 57 between the pump 56 and the head bar units 40Y-40K, it is preferable to provide a temperature sensor 51 at the exit point of the heater 57 in the ink-supplying pipe 52. When providing the cooler 58 between the heater 57 and the head bar units 40Y-40K, it is preferable to provide the temperature sensor 51 at the exit point of the cooler 58 in the ink-supplying pipe 52. A heater and a cooler that are same as the heater 28 and the cooler 27 of the second embodiment can be employed as the heater 57 and the cooler 58. The temperature sensor 51 provided at the head bar units 40Y-40K of the embodiments shown in FIGS. 11 and 12, and the heater 57 and cooler 58 correspond to the discharge fluid temperature detecting device and the discharge fluid temperature control device of the present invention, respectively.

The function of the inkjet printer 104 of the third embodiment will be described in the following.

When image signals are input into the head drive circuit, driving waves corresponding to these image signals are generated in the head drive circuit. The driving waves generated at the head drive circuit are input into the respective head drive ICs 4 disposed in each of the head bar units 40Y-40K.

In the head bar units 40Y-40K, the head drive ICs 4 select a specific drive wave from the input driving waves, select specific piezo elements to which the selected drive wave is to be input among the piezo elements of the head units 2A, and then input the selected driving wave into the selected piezo element. Due to this, ink is ejected from predetermined nozzles on the head units 2A and Y, M, C, K printing images are formed and a printing image in which these colors overlap each other is formed, whereby color printing images are formed.

the head drive ICs 4 generate heat at each of the head bar units 40Y-40K. Ink from inside the sub-tank 50 is supplied to the heat-dissipating block 42 through the ink-supplying pipe 52, passes through the ink pool 42A in the interior of the heat-dissipating block 42, goes through the ink-returning pipe 54, and returns to the sub-tank 50. For this reason, the heat generated at each head drive IC 4 is eliminated by the ink passing through the interior of the ink pool 42A of the heat-dissipating block 42.

Here, the ink in the sub-tank 50 passes through the ink-supplying pipe 52 and is supplied to each respective heat-dissipating block 42, and the ink that passed through the heat-dissipating block 42 passes through the respective ink-returning pipe 54 and returns to the sub-tank 50.

Accordingly, each of the heat-dissipating blocks 42 are maintained at the same temperature due to the ink passing through the ink pools 42A. Hence, even though the heat-dissipating blocks 42 are physically separate from each other, they are thermally connected to all of the eight head drive ICs 4 in each of the head bar units 40Y-40K via the ink flowing through the interior.

The temperature of the ink that returns to the sub-tank 50 from each of the heat-dissipating blocks 42 is detected by the temperature sensor 53. The drive conditions of the inkjet head 40 are determined based on the temperature detected by the temperature sensor 53.

Further, as shown in FIGS. 11 and 12, in embodiments that have the heater 57 and/or cooler 58 disposed on the ink-supplying pipe 52, not only the temperature sensor 53 detects the temperature of the ink returning to the sub-tank 50 and the drive conditions of the inkjet head 40 determined, but also the temperature sensor 51 detects the temperature of the ink supplied to each heat-dissipating block 42 from the ink-supplying pipe 52 and the heater 57 and cooler 58 are controlled so that predetermined temperature ink is supplied.

In the inkjet printer 104 of the third embodiment, it is not necessary to provide ink-supplying conduits separately from the discharge fluid flowing conduits so the inkjet heads 40 can be made more compact.

Further, ink is supplied to each of the heat-dissipating blocks 42 from the sub-tank 50 concurrently so, in the head bar units 40Y-40K, temperature fluctuations do not occur in the head drive ICs 4 and the head units 2A.

Accordingly, it is necessary only to determine the head drive conditions for each of the head bar units 40Y-40K, and thus, in comparison with a conventional apparatus, the logic and circuit structure of the head drive circuit can be greatly simplified.

### 4. Fourth Embodiment

In an inkjet printer 106, which is yet another example of the droplet discharging apparatus of the present invention, an inkjet head 2 has multiple, e.g., five head units 2A lined in a row in the longitudinal direction.

Ink is supplied to the head units 2A from an ink retention tank 13 in which ink is accumulated via an ink-supplying pipe 18 and ink-supplying pipes 19 branching off from the ink-supplying pipe 18.

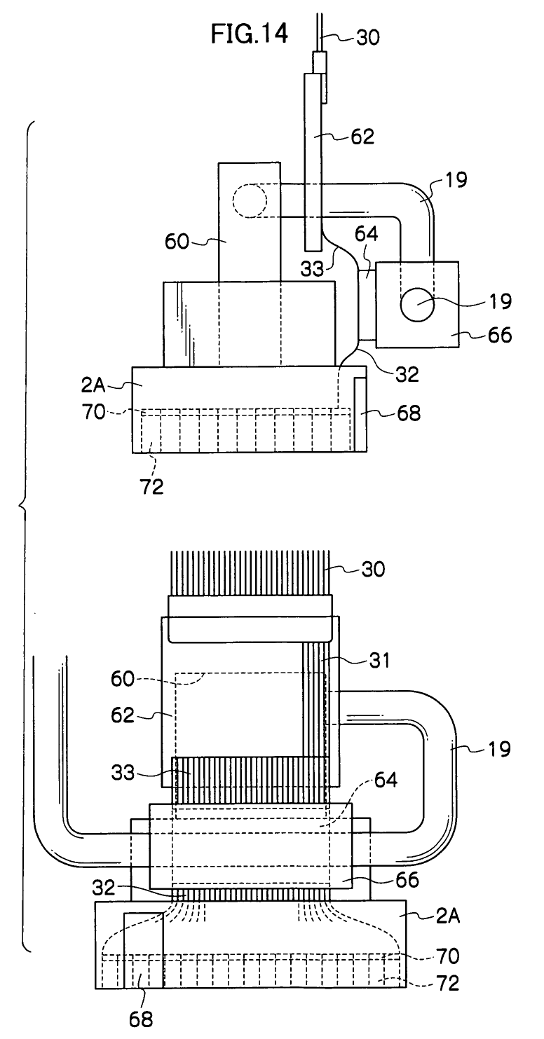

As shown in FIG. 14, a group of piezo elements 70 are provided in the interior of the head unit 2A, as well as nozzles 72 that eject ink downwards and which correspond to their respective piezo elements 70.

A sub-tank 60 that temporarily accumulates ink supplied from the ink-supplying pipe 19 is further provided at each head unit 2A.

The head units 2A further generate on/off signals and a switching IC 64 that drives the piezo elements 70 is connected with a flexible cable 32. A switching IC control board 62 is connected to the switching IC 64 by a flexible board 33. Each of the switching IC control boards 62 is connected to the head drive circuit 6 by a respective flexible cable 30. The switching IC control board 62 generates control signals, i.e., driving waves with commands of the head drive circuit 6, and controls the switching IC 64. A selection signal wiring 31, which transmits switching IC selection signals from the head drive circuit 6 to the switching IC 64, is provided on the switching IC control board 62.

A heat-dissipating block 66 transmitting heat generated at the switching IC 64 to the ink-supplying pipe 19 is thermally connected to the switching IC 64. The heat-dissipating block 66 is a heat sink and the ink-supplying pipe 19 passes through the interior thereof. In the inkjet printer 106, a heat pipe can be used in place of the heat-dissipating block 66 for transmitting the heat generated at the switching IC 64 to the ink-supplying pipe 19. The heat capacity of the heat-dissipating block 66 is determined so that the ink flowing through the ink-supplying pipe 19 can be heated at an appropriate temperature when discharging ink from all of the nozzles 72 in the head unit 2A.

A temperature sensor 68 is provided at the head unit 2A. The measurement results in the temperature sensor 68 are also input to the head drive circuit 6 via the flexible cable 32, the flexible board 33, and the flexible cable 30.

The inkjet printer 106 can have the same structure as the inkjet printer 100 of the first embodiment.

The function of the inkjet printer 106 will be described in the following.

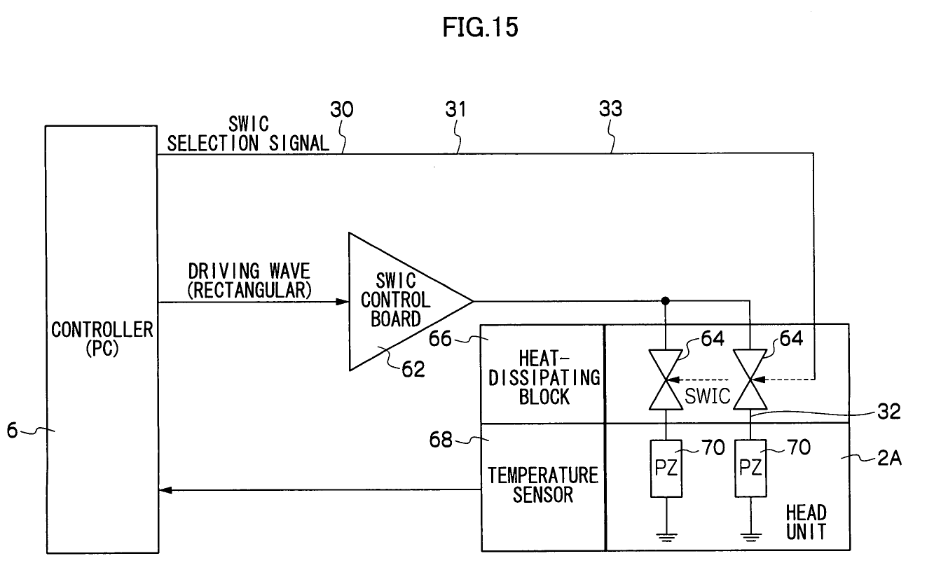

As shown in FIG. 15, The head drive circuit 6 generates a switching IC selection signal (hereafter, “SWIC selection signal”) that selects the switching IC 64 that is to be driven, and inputs the signal to the selected switching IC 64 via the flexible cable 30, the selection signal wiring 31, and the flexible board 33.

Then, the switching IC control board 62 generates a driving wave comprising one or two pulses in response to a command from the head drive circuit 6, and inputs the generated driving wave into the switching IC 64 in which the SWIC selection signal was input. Further, the driving waves formed with the head drive circuit 6 are input into a plurality of switching ICs 64 via the switching IC control board 62.

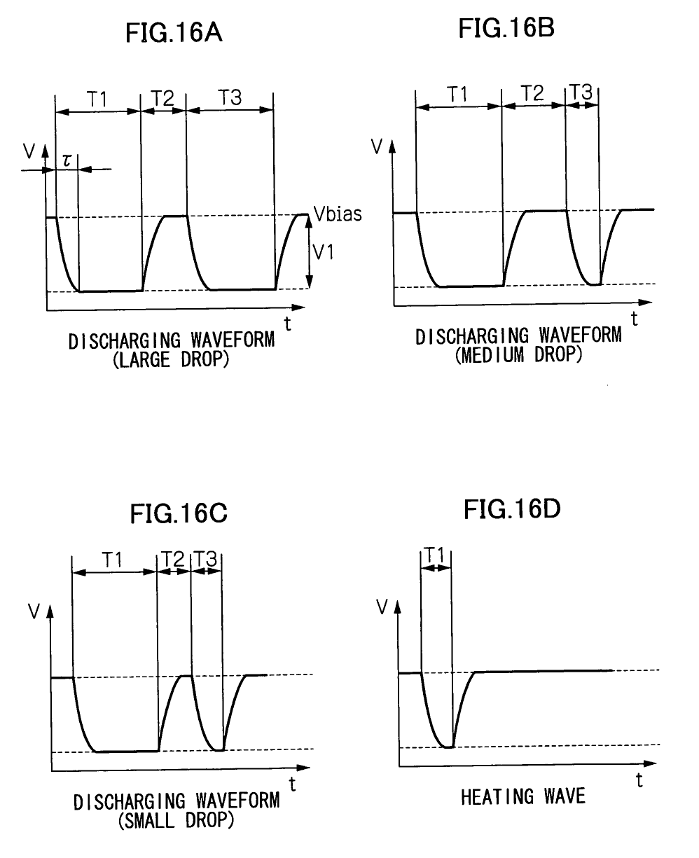

The driving waves that can be generated in the switching IC control board 62 are the discharging waves having the waveforms shown in FIGS. 16A, 16B, and 16C, as well as the heating wave having the waveform shown in FIG. 16D. These driving waves consist of one or two pulses having two extreme values of Vbias and V1. The discharging wave consists of two pulses and the heating wave consists of only one pulse. A period T1 is an intermission period of a first pulse and a period T3 is an intermission period of a second pulse. A period T2 is a period between the first and the second pulses. Although the Vbias, V1, and T1 in the present embodiment are 29 v, 15 v, and 1 μs, respectively, these values are not limited thereto.

When the driving waves from the switching IC control board 62 are input into the switching IC 64, the switching IC 64 drives the piezo elements 70 so as to be deformed by the first pulse in the direction that the nozzles 72 wherein the piezo elements 70 is disposed suction ink and by the second pulse in the direction that the nozzles 72 discharge the ink. Accordingly, as shown in FIG. 16A, when a driving wave having a waveform where both the first and second pulse are long is input, the piezo elements 70 deform largely both in suction direction and in the discharging direction and thus, ink droplets of large diameter are discharged from the nozzles 72. As shown in FIG. 16B, when a driving wave having a waveform consisting of a long first pulse, a short second pulse, and a long interval between the first and second pulses is input, ink droplets of medium diameter are discharged from the nozzles 72. As shown in FIG. 16C, a driving wave, of which wave form consists of a long first pulse, a short second pulse, and a short interval between the first and the second pulses, is input in the interval between the first and second pulses, droplets of smaller diameter are discharged from the nozzles 72. When driving waves are input from the switching IC control board 62 to the switching IC 64 in this manner, the switching IC 64 generates heat while driving the piezo elements 70 to discharge large, medium, or small-sized droplets from the nozzles 72 in accordance with the input waveforms.

Meanwhile, the heating wave, as shown in FIG. 16D, consisting of only one short pulse and when the heating wave is input, the switching IC 64 drives the piezo elements 70 at such a small vibration amplitude that ink is not discharged from the nozzles 72 while simultaneously generating heat.

As previously described, the switching IC 64 is thermally connected with the heat-dissipating block 66 and the ink-supplying pipe 19 passes through the heat-dissipating block 66, so the ink flowing through the ink-supplying pipe 19 is heated by the heat generated at the switching IC 64.

The temperature sensor 68 detects the temperature of the head unit 2A and inputs it to the head drive circuit 6. While flowing through the ink-supplying pipe 19, the ink is heated by the heat-dissipating block 66 and supplied to the sub-tank 60. Then the ink is temporarily retained in the sub-tank 60 and discharged from the nozzles 72. Accordingly, the temperature of the head unit 2A and the temperature of the discharged ink can be considered to be substantially equal.

When the input temperature is lower than an optimum temperature range of the ink, the head drive circuit 6 inputs a SWIC selection signal to the switching IC 64 driving the piezo elements 70 of the nozzles 72 not discharging ink, and applies a heating wave to the switching IC 64 via the switching IC control board 62 and heats the ink more intensively.

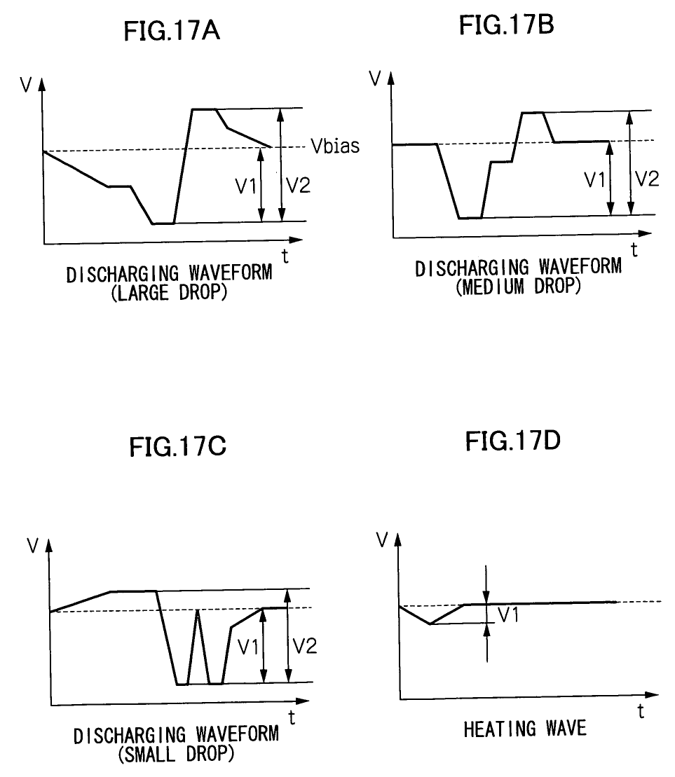

In the inkjet printer 106, an analog waveform shown in FIG. 17 can be generated in order to drive the piezo elements 70. In this case, the heat-dissipating block 66 is thermally connected with the drive IC and the heat of the drive IC can be conveyed to the ink in the ink-supplying pipe 19.

In the following, function of the inkjet printer 106 in a printing preparation condition, in a printing condition, and in a printing termination condition will be described.

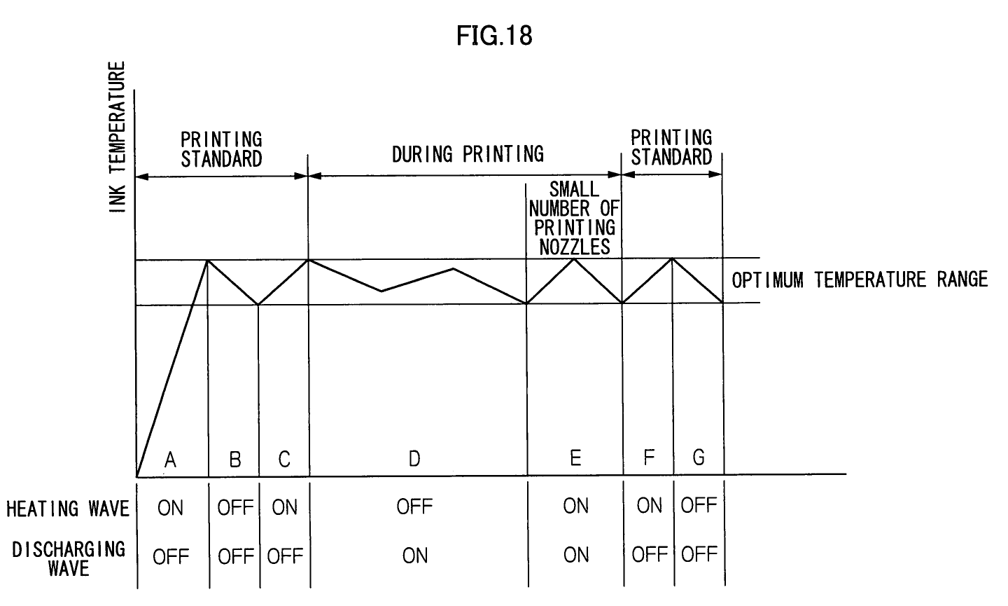

As shown in FIG. 18, before starting printing, the ink temperature, that is, the temperature of the head unit 2A measured by the temperature sensor 68, is normally lower than the optimum ink temperature range of, for example, 30-35° C. Accordingly, as shown in FIG. 18 in the A zone, the head drive circuit 6 selects all of the switching ICs 64 and inputs heating waves via the switching IC control board 62. Due to this, ink is not discharged from the nozzles 72 but the switching ICs 64 generate heat and the ink is heated.

The temperature of the ink rises and when it reaches the upper limit of the optimum temperature range, the head drive circuit 6 inputs a command to the switching IC control board 62 commanding to cease generating heating waves, as shown in zone B of FIG. 18. When the command is input, the switching IC control board 62 ceases generating heating waves and the switching IC 64 stops generating heat and thus, the ink temperature goes down. Then, when the ink temperature reaches a lower limit of the optimum temperature range, the switching IC control board 62 resumes generation of heating waves to heat the switching IC 64 and the ink is heated.

When printing, the head drive circuit 6 selects the switching IC 64 driving the nozzles 72 that should eject ink in accordance with the image data to be printed, and inputs discharging wave via the switching IC control board 62 to the selected switching IC 64 and drives the piezo elements 70, and ink droplets of a predetermined size are discharged from the nozzles 72. As shown in zone D in FIG. 18, if the ink temperature is within the optimum temperature range due to the heat generated from the switching IC 64, the head drive circuit 6 does not select the nozzles 72 not discharging ink so as to input heating waves.

Meanwhile, when the printing density decreases during printing and lesser number of the nozzles 72 discharges ink so that the ink temperature reaches the lower limit of the optimum temperature range, as seen in zone E in FIG. 18 the head drive circuit 6 inputs heating waves to all of the switching ICs 64. Therefore, both discharging waves and heating waves are input into the switching ICs 64 driving the nozzles 72 that is discharging ink, while only heating waves are input into the switching ICs 64 corresponding to the nozzles 72 that is not discharging ink. Consequently, the ink temperature is maintained within the optimum temperature range when the printing density is not only high but low.

When printing is completed and the inkjet printer 106 is transited from the printing condition to the printing preparation condition, the head drive circuit 6 stops inputting the discharging waves to the switching ICs 64 and inputs only heating waves, as shown in zone F in FIG. 18. When the ink temperature reaches the upper limit of the optimum temperature range, inputting of the heating waves is stopped, as shown in zone G.

As described above, in the inkjet printer 106, the ink is heated with residual heat from the switching ICs 64 and thus, a heater for heating the ink becomes unnecessary. Further, even pigment ink with high viscosity at room temperature can be heated to the optimum temperature range and discharged, consequently, the ink can be discharged at a high discharging efficiency from the nozzles 72 and even high-density images can be clearly reproduced.

The droplet discharging apparatus of the present invention includes not only an inkjet recording apparatus discharging pigment or dye ink to a recording paper to print an image, but also circuit printing apparatus that discharges conductive ink as the discharge fluid in a droplet form on a substrate to print circuits.

Not only an inkjet recording apparatus having piezoelectric inkjet-type heads driven by multiple piezo elements but also an inkjet recording apparatus provided with thermal inkjet-type inkjet heads where pulses are applied to a heater disposed in the pressure chamber and ink is ejected from the head can be mentioned as examples of the inkjet recording apparatus that is included in the present invention.

As described above, with the droplet discharging apparatus of the present invention, cooling of the discharging heads is performed with heat-dissipating blocks thermally connected with multiple head drive elements. For this reason, even with discharging heads structured from multiple head units such as paper-width heads, each of the respective head units can be cooled evenly and cooling irregularities do not occur.

Accordingly, each head unit can be driven as an entire discharging head with the same drive conditions. This is why control of the head units and the head drive circuit that inputs drive signals to the drive elements can be simplified.

Further, the discharge fluid itself that is to be discharged from the discharging heads is made to flow through the heat-dissipating blocks, thereby cooling the blocks. Hence, the cooling system can be structured to be more compact than systems that require circulating water or coolant.

The second aspect of the present invention relates to the droplet discharging apparatus of the first aspect wherein the discharge fluid flowing conduits form a portion of the discharge fluid supply conduits of the discharging heads.

In this droplet discharging apparatus, as with the droplet discharging apparatus recited in the first aspect, cooling of the discharging heads is performed with the heat-dissipating blocks that are thermally connected to the multiple head drive elements, so even in discharging heads structured from multiple head units, as is the case with paper-width heads, each of the respective head units can be cooled evenly and cooling irregularities do not occur.

Accordingly, each head unit can be driven as an entire discharging head with the same drive conditions, so control of the head units and the head drive circuit that inputs drive signals to the drive elements can be simplified.

Further, the ejected discharge fluid itself in the discharging heads is made to flow through the interiors of the heat-dissipating blocks, thereby cooling the blocks. Hence, the cooling system can be structured to be more compact than systems that require circulating water or coolant.

Furthermore, it is not necessary to form discharge fluid supplying conduits separately from the discharge fluid flowing conduits, so the entire droplet discharging apparatus can be structured in a more compact manner.

The third aspect of the present invention relates to the droplet discharging apparatus of the first aspect wherein the discharge fluid flowing conduits are formed separately from the supplying conduits that supply discharge fluid to the discharging heads.

With this droplet discharging apparatus, the discharge fluid flowing conduits are provided separately from the discharge fluid supplying conduits, so cooling of the heat-dissipating blocks can be performed in the discharging heads without any relation to the ejecting of the discharge fluid. Accordingly, cooling of the heat-dissipating blocks can be performed while discharging the discharge fluid, so if this droplet discharging apparatus is used as the inkjet recording device, reduction of throughput that ordinarily accompanies cooling of the heat-dissipating blocks can be prevented.

The fourth aspect of the present invention involves the droplet discharging apparatus of the first to the third aspects, where the droplet discharging head is provided with multiple ejecting elements that each have one discharge fluid chamber and nozzles communicated with the discharge fluid chamber. The head drive element inputs a predetermined discharging wave to a predetermined ejecting element and makes it discharge the discharge fluid. The heat-dissipating blocks heat the discharge fluid flowing through the discharge fluid flowing conduits provided in the interior thereof with the heat from the head drive elements.

In comparison with discharge fluid having low viscosity at room temperature, such as dye ink, the discharging efficiency of discharge fluid having high viscosity at room temperature, such as the above-described pigment ink, is lower at the same temperature.

However, with the present invention, the heat generated at the head drive elements is conveyed to the discharge fluid via a heat-conveying device, so the discharge fluid is heated and the viscosity lowered. Due to this, even with discharge fluids having high viscosity at room temperature such as pigment ink, the fluid can be discharged from the nozzles with high discharging efficiency without placing an especially large burden on the head drive circuit.

Furthermore, the residual heat from the head drive elements is used to heat the discharge fluid, so it is not necessary to add a special element to heat the discharge fluid. For this reason, there is no undue complication of the structure of the droplet discharging apparatus.

The fifth aspect of the present invention relates to the droplet discharging apparatus of the fourth aspect wherein the head drive elements generate waveforms that do not discharge the discharge fluid, such as heating waves, and inputs them to at least a part of ejecting elements that do not discharge the discharge fluid.

In cases where there are many nozzles from which discharge fluid is not being discharged, such as when the discharging density of the discharge fluid is low, the output of the head drive circuit is also low. There is thus a possibility of the discharge fluid being insufficiently heated.

However, with the present droplet discharging apparatus, heating waves are input to the ejecting elements not discharging discharge fluid from the nozzles. Hence, despite the fact that these ejecting elements are not discharging droplets, heat sufficient enough to heat the discharge fluid to a predetermined temperature can be generated.

The sixth aspect of the present invention relates to the droplet discharging apparatus of the fifth aspect, where the discharging heads overlap and apply both the discharging waves and the heating waves to the ejecting elements that are to discharge the discharge fluid.

Nonetheless, even when the discharging speed has slowed, the output of the head drive circuit decreases so there is the possibility of the discharge fluid being insufficiently heated.

In the droplet discharging apparatus of the present aspect, the discharging waves and the heating waves are overlapped and applied to the ejecting elements that are to discharge the discharge fluid. Due to this, the head drive circuit can generate greater output than when compared to when only heating waves are generated, so the discharge fluid can be sufficiently heated.

The seventh aspect of the present invention relates to the droplet discharging apparatus of the first to the sixth aspects further comprising a discharge fluid temperature detecting device detecting the temperature of the discharge fluid flowing through the discharge fluid flowing conduits and a discharge fluid flow control device controlling the amount of discharge fluid circulating inside the heat-dissipating blocks based on the discharge fluid temperature detected by the discharge fluid temperature detecting device.

In the above droplet discharging apparatus, the amount of discharge fluid circulating inside the heat-dissipating blocks is controlled based on the discharge fluid temperature detected by the discharge fluid temperature detecting device. Thus, even in case when the head drive elements suddenly heat, like a case when printing a whole area by an inkjet recording head, sudden temperature increases in the drive elements can be prevented.

Methods for controlling the flow amount of discharge fluid wherein the flow amount is increased when the discharge fluid temperature is high, and the flow amount is decreased when the discharge fluid temperature is low is included in embodiments of the methods for controlling the flow amount of discharge fluid based on the discharge fluid temperature detected by the discharge fluid temperature detecting device.

The eighth aspect of the present invention relates to the droplet discharging apparatus of the seventh embodiment further comprising a discharge fluid heating device and a discharge fluid cooling device both of which are provided at the discharge fluid flowing conduits.

In the above droplet discharging apparatus, when, for example, the temperature of the discharge fluid will not rise above a lower-limit predetermined temperature T1 even if the amount of discharge fluid being circulated is reduced to the lowest circulation amount, the discharge fluid is heated with the discharge fluid heating device so that the temperature can be maintained above the lower-limit predetermined temperature T1. Further, when the temperature of the discharge fluid exceeds an upper-limit predetermined temperature T2 even if the amount of discharge fluid being circulated is increased to the highest circulation amount, the discharge fluid is cooled with the discharge fluid cooling device so that the temperature can be maintained below the upper-limit predetermined temperature T2.

Thus, temperature variations in the discharge fluid can be suppressed especially effectively and the occurrence of density irregularities in the images due to discharge fluid temperature variations can be especially prevented effectively.

The ninth aspect of the present invention relates to the droplet discharging apparatus of the first to the eighth aspects, wherein the discharging heads are piezoelectric type heads driven by piezo elements to which drive signals are transmitted by the head drive elements.

As previously described, although the piezoelectric heads themselves rarely generate heat when ejecting the discharge fluid, when the size of the discharging heads is increased, the numbers of discharging nozzles and piezo elements corresponding thereto also increase. In accordance with the increase of the numbers of discharging nozzles and piezo elements, it is necessary to increase the degree of accumulation of the head drive elements so that the overall amount of heat generated from the head drive elements increases.

However, with the present droplet discharging apparatus, the discharge fluid is made to flow through the heat-dissipation blocks and the heat generated by the head drive elements is eliminated, whereby heat accumulation in the head drive elements and impeding of the driving of the discharging heads resulted therefrom is prevented.

As described above, by the present invention, a droplet discharging apparatus comprising multiple head units wherein cooling irregularities do not occur and the drive elements can be effectively cooled can be provided. The above recitations relating to the embodiments of the present invention were given in order provide specific explanations of the present invention, and are not intended to limit the boundaries recited in the claims and the embodiments disclosed with the above recitations. Many variations of the present invention besides those disclosed above are possible, and these would be obvious to those skilled in the art. The above-described examples of the embodiments were selected for being the best for explaining the present invention and applications in actual practice. Based on these examples, those skilled in the art can understand that there are various alternate examples of the present invention that can be made possible.

What is claimed is:

1. A droplet discharging apparatus comprising:
a plurality of droplet discharging heads that discharge a discharge fluid in droplet form;
a plurality of head drive elements that drive the droplet discharging heads; and
a heat-dissipating block that is thermally connected to the respective head drive elements and which has a discharge fluid flowing conduit therein that cools the head drive elements by making the discharge fluid flow therethrough.

2. The droplet discharging apparatus of claim 1, wherein the discharge fluid flowing conduit forms a portion of a supply conduit for the discharge fluid to the discharging heads.

3. The droplet discharging apparatus of claim 1, wherein the discharge fluid flowing conduit is formed separately from a supply conduit supplying discharge fluid to the discharging heads.

4. The droplet discharging apparatus of claim 2, wherein the droplet discharging head is provided with a plurality of ejecting elements having a discharge fluid chamber and a nozzle communicating with the discharge fluid chamber; where
the head drive element inputs predetermined discharging waveforms into predetermined ejecting elements and makes discharge fluid discharge from the ejecting elements; and
the heat-dissipating block heats the discharge fluid flowing through the discharge fluid flowing conduit provided in the interior thereof.

5. The droplet discharging apparatus of claim 3, wherein the droplet discharging head is provided with a plurality of ejecting elements having a discharge fluid chamber and a nozzle communicating with the discharge fluid chamber; where
the head drive element inputs predetermined discharging waveforms into predetermined ejecting elements and makes discharge fluid discharge from the ejecting elements; and
the heat-dissipating block heats the discharge fluid flowing through the discharge fluid flowing conduit provided in the interior thereof.

6. The droplet discharging apparatus of claim 4, wherein the head drive element generates a heating wave that is a waveform by which discharge fluid is not discharged and inputs the heating wave to at least a part of the ejecting elements that do not discharge the discharge fluid.

7. The droplet discharging apparatus of claim 5, wherein the head drive element generates a heating wave that is a waveform by which discharge fluid is not discharged and inputs the heating wave to at least a part of the ejecting elements that do not discharge the discharge fluid.

8. The droplet discharging apparatus of claim 6, wherein the discharging head overlaps the discharging waveform and the heating wave and applies them to the ejecting element that discharges the discharge fluid.

9. The droplet discharging apparatus of claim 7, wherein the discharging head overlaps the discharging waveform and the heating wave and applies them to the ejecting element that discharges the discharge fluid.

10. The droplet discharging apparatus of claim 1 further comprising:
a discharge fluid temperature detecting device that detects the temperature of the discharge fluid flowing through the discharge fluid flowing conduit; and
a discharge fluid flow amount control device that controls the flow amount of discharge fluid circulating inside the heat-dissipating block based on the discharge fluid temperature detected with the discharge fluid temperature detecting device.

11. The droplet discharging apparatus of claim 2 further comprising:
a discharge fluid temperature detecting device that detects the temperature of the discharge fluid flowing through the discharge fluid flowing conduit; and
a discharge fluid flow amount control device that controls the flow amount of discharge fluid circulating inside the heat-dissipating block based on the discharge fluid temperature detected with the discharge fluid temperature detecting device.

12. The droplet discharging apparatus of claim 3 further comprising:
a discharge fluid temperature detecting device that detects the temperature of the discharge fluid flowing through the discharge fluid flowing conduit; and
a discharge fluid flow amount control device that controls the flow amount of discharge fluid circulating inside the heat-dissipating block based on the discharge fluid temperature detected with the discharge fluid temperature detecting device.

13. The droplet discharging apparatus of claim 10 further comprising a discharge fluid heating device and a discharge fluid cooling device provided at the discharge fluid flowing conduit.

14. The droplet discharging apparatus of claim 11 further comprising a discharge fluid heating device and a discharge fluid cooling device provided at the discharge fluid flowing conduit.

15. The droplet discharging apparatus of claim 12 further comprising a discharge fluid heating device and a discharge fluid cooling device provided at the discharge fluid flowing conduit.

16. The droplet discharging apparatus of claim 1, wherein the discharging heads are piezoelectric-type discharging heads driven by a piezo element and the head drive elements transmit drive signals to the piezo element.
